(19) United States
(12) Patent Application Publication
(10) Pub. No.: US 2023/0184624 A1
(43) Pub. Date: Jun. 15, 2023

(54) Fault Diagnosis Method and Apparatus Therefor

(71) Applicant: Siemens Aktiengesellschaft, München (DE)

(72) Inventors: Hong Wei Wang, Beijing (CN); Ming Jie, Beijing (CN); Shun Jie Fan, Beijing (CN)

(73) Assignee: Siemens Aktiengesellschaft, München (DE)

(21) Appl. No.: 17/921,489

(22) PCT Filed: Apr. 27, 2020
(86) PCT No.: PCT/CN2020/087312

§ 371 Date: Oct. 26, 2022

(51) Int. Cl. G01M 13/045

(52) U.S. Cl. CPC G01M 13/045

(57) ABSTRACT

Various embodiments include a fault diagnosis method for a rotating motor. The method may include: obtaining a time-domain acceleration signal of the rotating motor along a vibration direction and a rotation period of the rotating motor; converting the time-domain acceleration signal into a time-domain velocity signal, cutting off a plurality of velocity signal segments along the time-domain velocity signal by taking the rotation period as a step size, and arranging the plurality of velocity signal segments in sequence to obtain a velocity signal matrix; converting the velocity signal matrix into an image; and inputting the image into a trained neural network model to obtain a fault diagnosis result.

### CROSS-REFERENCE TO RELATED APPLICATIONS

This application is a U.S. National Stage Application of International Application No. PCT/CN2020/087312 filed Apr. 27, 2020, which designates the United States of America, the contents of which are hereby incorporated by reference in their entirety.

### TECHNICAL FIELD

The present disclosure mainly relates to the field of computer technologies. Various embodiments of the teachings herein include fault diagnosis methods and/or systems.

### BACKGROUND

In industrial systems, the performance of mechanical apparatuses such as rotating motors plays a very important role. Monitoring the status of and performing fault diagnosis on these mechanical apparatuses in a timely manner may predict an abnormal state of the mechanical apparatuses in a timely manner before the apparatuses are actually faulty, thereby ensuring that these mechanical apparatuses operate with good performance.

During fault diagnosis on a mechanical apparatus, various types of signals are collected from the mechanical apparatus, among which more commonly used signals are vibration signals in different positions and directions. When a vibration signal is used for fault diagnosis, the vibration signal is first collected, and then a series of analyses are performed on the vibration signal, for example, the vibration signal may be analyzed according to the international standards ISO 13373-1, ISO 13373-2, and ISO 13373-3, to determine whether there is a fault and a type of the fault.

Technical personnel needs to have related domain knowledge to perform spectrum analysis on the vibration signal, which limits the application of fault diagnosis based on vibration signals. With the rapid development of the artificial intelligence technology, this technology was attempted to be used for fault diagnosis. However, in an existing neural network model, acceleration hardware (such as a network processing unit (NPU)) and a platform (such as TensorFlow and Caffe) thereof are mainly oriented to use for image, text, and voice data, and are not applicable to vibration signals required for fault diagnosis. In addition, different types of vibration sensors have different sampling rates and resolutions, and in this case, a single neural network model is not applicable. To obtain a more accurate diagnosis result, the neural network model needs to be trained separately using vibration data with different sampling rates and resolutions, which will increase training complexity and training time.

### SUMMARY

To solve the above technical problems, the teachings of the present disclosure include fault diagnosis methods and/or systems, so as to transform a fault diagnosis problem into an image recognition problem, which is applicable to an image-oriented neural network model and improves fault diagnosis efficiency and accuracy. For example, some embodiments include a fault diagnosis method (200) for a rotating motor, the fault diagnosis method (200) comprising: obtaining a time-domain acceleration signal of the rotating motor along a vibration direction and a rotation period (210) of the rotating motor; converting the time-domain acceleration signal into a time-domain velocity signal, cutting off a plurality of velocity signal segments along the time-domain velocity signal by taking the rotation period as a step size, and arranging the plurality of velocity signal segments in sequence to obtain a velocity signal matrix (220); converting the velocity signal matrix into an image (230); and inputting the image into a trained neural network model to obtain a fault diagnosis result (240).

In some embodiments, the converting the time-domain acceleration signal into a time-domain velocity signal comprises: converting the time-domain acceleration signal into a frequency-domain acceleration signal through fast Fourier transform; performing frequency-domain integration on the frequency-domain acceleration signal to obtain a frequency-domain velocity signal; and converting the frequency-domain velocity signal into the time-domain velocity signal through inverse fast Fourier transform.

In some embodiments, cutting off a plurality of velocity signal segments along the time-domain velocity signal by taking the rotation period as a step size comprises cutting off the plurality of velocity signal segments along the time-domain velocity signal in a non-overlapping manner by taking the rotation period as the step size.

In some embodiments, the converting the velocity signal matrix into an image comprises: multiplying the velocity signal matrix by a normalization coefficient to obtain a normalized velocity signal matrix; and mapping the normalized velocity signal matrix to the image.

In some embodiments, the converting the velocity signal matrix into an image (230) comprises converting the velocity signal matrix into a color image.

In some embodiments, after the converting the velocity signal matrix into an image (230), the method further comprises adjusting a size of the image to a predetermined size for the neural network model.

As another example, some embodiments include a fault diagnosis apparatus (400) for a rotating motor, the fault diagnosis apparatus (400) comprising: an obtaining unit (410) obtaining a time-domain acceleration signal of the rotating motor along a vibration direction and a rotation period of the rotating motor; an alignment and arrangement unit (420) converting the time-domain acceleration signal into a time-domain velocity signal, cutting off a plurality of velocity signal segments along the time-domain velocity signal by taking the rotation period as a step size, and arranging the plurality of velocity signal segments in sequence to obtain a velocity signal matrix; a conversion unit (430) converting the velocity signal matrix into an image; and a determining unit (440) inputting the image into a trained neural network model to obtain a fault diagnosis result.

In some embodiments, the converting, by the obtaining unit (410), the time-domain acceleration signal into a time-domain velocity signal comprises: converting the time-domain acceleration signal into a frequency-domain acceleration signal through fast Fourier transform; performing frequency-domain integration on the frequency-domain acceleration signal to obtain a frequency-domain velocity signal; and converting the frequency-domain velocity signal into the time-domain velocity signal through inverse fast Fourier transform.

In some embodiments, the cutting off, by the alignment and arrangement unit (420), a plurality of velocity signal segments along the time-domain velocity signal by taking the rotation period as a step size comprises: cutting off the plurality of velocity signal segments along the time-domain velocity signal in a non-overlapping manner by taking the rotation period as the step size.

In some embodiments, converting, by the conversion unit (430), the velocity signal matrix into an image comprises: multiplying the velocity signal matrix by a normalization coefficient to obtain a normalized velocity signal matrix; and mapping the normalized velocity signal matrix to the image.

In some embodiments, the converting, by the conversion unit (430), the velocity signal matrix into an image comprises converting the velocity signal matrix into a color image.

In some embodiments, after the converting, by the conversion unit (430), the velocity signal matrix into an image, the following further comprises adjusting a size of the image to a predetermined size for the neural network model.

As another example, some embodiments of the teachings herein include an electronic device, comprising a processor, a memory, and instructions stored in the memory, wherein when the instructions are executed by the processor, one or more of the methods described herein are implemented.

As another example, some embodiments include a computer-readable storage medium having computer instructions stored thereon, wherein when the computer instructions are run, one or more of the methods described herein is performed.

### BRIEF DESCRIPTION OF THE DRAWINGS

The following accompanying drawings are only intended to illustratively describe and explain the teachings of the present disclosure and not intended to limit the scope of the present disclosure. In the accompanying drawings,

FIG. 1 is a schematic diagram of a fault diagnosis model in the prior art;

FIG. 2 is a flowchart of a fault diagnosis method incorporating teachings of the present disclosure;

FIG. 3 is a schematic diagram of a process of a fault diagnosis method incorporating teachings of the present disclosure; and

FIG. 4 is a block diagram of a fault diagnosis apparatus incorporating teachings of the present disclosure.

### DESCRIPTION OF REFERENCE NUMERALS

100 Fault diagnosis model
110 Data collection unit
120 Preprocessing unit
130 Feature extraction unit
140 Diagnosis unit
141 Diagnosis algorithm
150 Training set input unit
200 Fault diagnosis method
210-240 Steps
301 Time-domain acceleration signal
302 Time-domain velocity signal
302a-302d Velocity signal segments
303 Velocity signal matrix
303a Local magnified part of the velocity signal matrix
304 Normalized velocity signal matrix
304a Local magnified part of the normalized velocity signal matrix
305 Image
306 Image with an adjusted size
400 Fault diagnosis apparatus
410 Obtaining unit
420 Alignment and arrangement unit
430 Conversion unit
440 Determining unit

### DETAILED DESCRIPTION

To achieve the above objectives, the teachings of the present disclosure include a fault diagnosis method for a rotating motor, the fault diagnosis method including: obtaining a time-domain acceleration signal of the rotating motor along a vibration direction and a rotation period of the rotating motor; converting the time-domain acceleration signal into a time-domain velocity signal, cutting off a plurality of velocity signal segments along the time-domain velocity signal by taking the rotation period as a step size, and arranging the plurality of velocity signal segments in sequence to obtain a velocity signal matrix; converting the velocity signal matrix into an image; and inputting the image into a trained neural network model to obtain a fault diagnosis result. For this purpose, the velocity signal matrix is converted into the image, and the image is input into the trained neural network model, so that the fault diagnosis result is obtained, thereby transforming a fault diagnosis problem into an image recognition problem, which is applicable to an image-oriented neural network model and improves fault diagnosis efficiency and accuracy.

In some embodiments, the converting the time-domain acceleration signal into a time-domain velocity signal includes: converting the time-domain acceleration signal into a frequency-domain acceleration signal through fast Fourier transform; performing frequency-domain integration on the frequency-domain acceleration signal to obtain a frequency-domain velocity signal; and converting the frequency-domain velocity signal into the time-domain velocity signal through inverse fast Fourier transform. For this purpose, frequency-domain integration is used to remove high-frequency noise in a vibration signal.

In some embodiments, the cutting off a plurality of velocity signal segments along the time-domain velocity signal by taking the rotation period as a step size includes: cutting off the plurality of velocity signal segments along the time-domain velocity signal in a non-overlapping manner by taking the rotation period as the step size. For this purpose, the plurality of velocity signal segments are cut off along the time-domain velocity signal in a non-overlapping manner by taking the rotation period as the step size, and adjacent velocity signal segments from the plurality of velocity signal segments do not overlap, thereby improving data stability and fault diagnosis accuracy.

In some embodiments, the converting the velocity signal matrix into an image includes: multiplying the velocity signal matrix by a normalization coefficient to obtain a normalized velocity signal matrix; and mapping the normalized velocity signal matrix to the image. For this purpose, the velocity signal matrix is normalized, such that vibration data with different sampling rates and resolutions are all applicable, thereby reducing complexity of the neural network model and improving fault diagnosis efficiency.

In some embodiments, the converting the velocity signal matrix into an image includes: converting the velocity signal matrix into a color image. For this purpose, the velocity signal matrix is converted into the color image, which can increase an image recognition degree and facilitate labeling by technical personnel during training of the neural network model, thereby improving the accuracy of the neural network model for fault diagnosis.

In some embodiments, after the converting the velocity signal matrix into an image, the method further includes: adjusting a size of the image to a predetermined size for the neural network model. For this purpose, the size of the image is adjusted to the predetermined size for the neural network model, which can reduce the complexity of the neural network model and improve the fault diagnosis efficiency.

In some embodiments, a fault diagnosis apparatus for a rotating motor includes: an obtaining unit obtaining a time-domain acceleration signal of the rotating motor along a vibration direction and a rotation period of the rotating motor; an alignment and arrangement unit converting the time-domain acceleration signal into a time-domain velocity signal, cutting off a plurality of velocity signal segments along the time-domain velocity signal by taking the rotation period as a step size, and arranging the plurality of velocity signal segments in sequence to obtain a velocity signal matrix; a conversion unit converting the velocity signal matrix into an image; and a determining unit inputting the image into a trained neural network model to obtain a fault diagnosis result.

In some embodiments, converting, by the obtaining unit, the time-domain acceleration signal into a time-domain velocity signal includes: converting the time-domain acceleration signal into a frequency-domain acceleration signal through fast Fourier transform; performing frequency-domain integration on the frequency-domain acceleration signal to obtain a frequency-domain velocity signal; and converting the frequency-domain velocity signal into the time-domain velocity signal through inverse fast Fourier transform.

In some embodiments, cutting off, by the alignment and arrangement unit, a plurality of velocity signal segments along the time-domain velocity signal by taking the rotation period as a step size includes: cutting off the plurality of velocity signal segments along the time-domain velocity signal in a non-overlapping manner by taking the rotation period as the step size.

In some embodiments, converting, by the conversion unit, the velocity signal matrix into an image includes: multiplying the velocity signal matrix by a normalization coefficient to obtain a normalized velocity signal matrix; and mapping the normalized velocity signal matrix to the image.

In some embodiments, converting, by the conversion unit, the velocity signal matrix into an image includes converting the velocity signal matrix into a color image.

In some embodiments, after the converting, by the conversion unit, the velocity signal matrix into an image, the following step is further included adjusting a size of the image to a predetermined size for the neural network model.

In some embodiments, there is an electronic device, including a processor, a memory, and instructions stored in the memory, where when the instructions are executed by the processor, one or more of the methods as described above is implemented.

In some embodiments, there is a computer-readable storage medium having computer instructions stored thereon, where when the computer instructions are run, one or more of the method as described above is performed.

For the sake of better understanding of the technical features, objects, and effects of the teachings of the present disclosure, some example embodiments will now be described with reference to the accompanying drawings. In the following description, many specific details are set forth, but the teachings of the present disclosure can also be implemented in other ways different from those described herein. Therefore, the scope of the present disclosure is not limited by the specific embodiments disclosed below.

As shown in the present application and the claims, unless the context expressly indicates otherwise, the words “a”, “an”, “said”, and/or “the” do not specifically refer to the singular, but may also include the plural. Generally, the terms “include” and “comprise” only suggest that the expressly identified steps and elements are included, but these steps and elements do not constitute an exclusive list, and the method or device may further include other steps or elements.

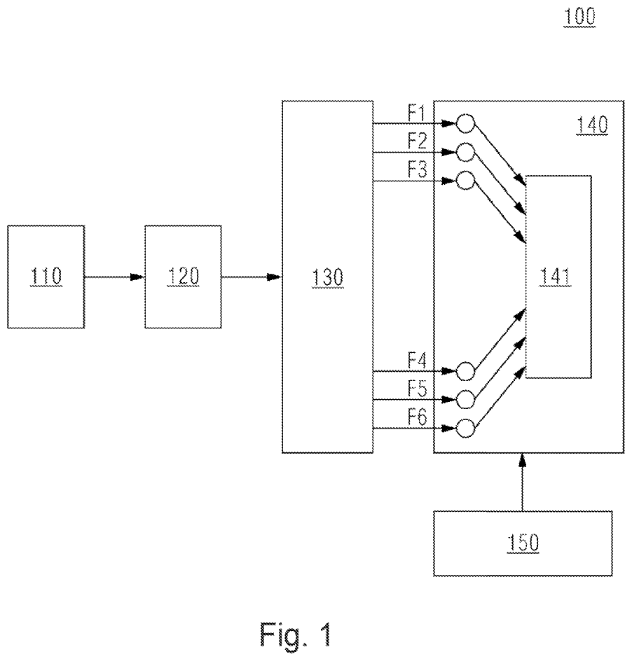

FIG. 1 is a schematic diagram of a fault diagnosis model 100 in the prior art. As shown in FIG. 1, the fault diagnosis model 100 includes a data collection unit 110, a preprocessing unit 120, a feature extraction unit 130, a diagnosis unit 140, and a training set input unit 150.

When the fault diagnosis model 100 performs fault diagnosis, the data collection unit 110 (for example, an acceleration sensor) collects a vibration signal of a rotating motor along a vibration direction, and the preprocessing unit 120 preprocesses the vibration signal for analysis and processing by subsequent modules. For example, the preprocessing unit performs fast Fourier transform (FFT) on the vibration signal to convert the time-domain vibration signal into a frequency-domain vibration signal; the feature extraction unit 130 performs spectrum analysis on the frequency-domain vibration signal to extract feature frequency; the diagnosis unit 140 uses a diagnosis algorithm 141 to perform diagnosis on the input feature frequency, and outputs a diagnosis result; and the training set input unit 150 inputs a training set into the diagnosis unit 140 to train the diagnosis unit 140.

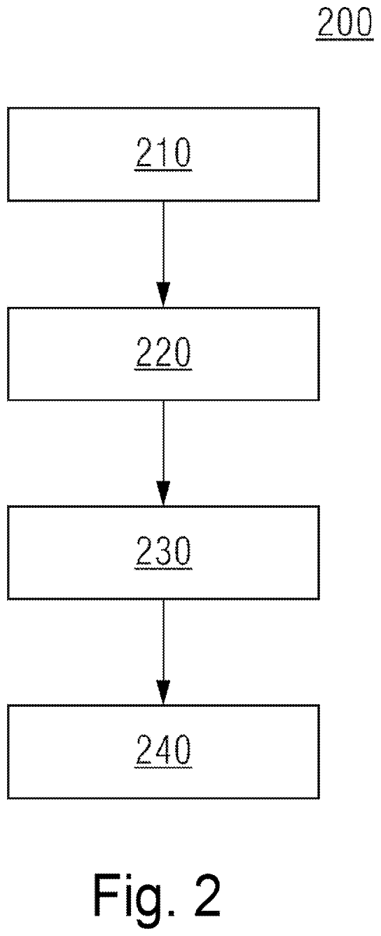

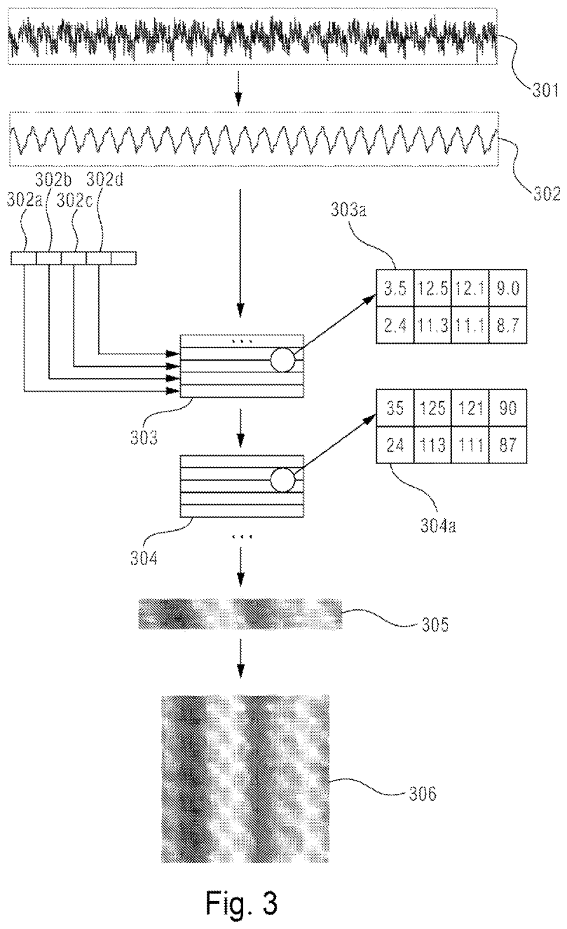

For the fault diagnosis model 100, different types of data collection units 110 have different sampling rates and resolutions, and in this case, a single neural network model is not applicable. To obtain a more accurate diagnosis result, the neural network model needs to be trained separately using vibration data with different sampling rates and resolutions, which will increase training complexity and training time. FIG. 2 is a flowchart of a fault diagnosis method incorporating teachings of the present disclosure. FIG. 3 is a schematic diagram of a process of a fault diagnosis method incorporating teachings of the present disclosure. The fault diagnosis method in this embodiment is described below with reference to FIG. 2 and FIG. 3.

In step 210, a time-domain acceleration signal of a rotating motor along a vibration direction and a rotation period of the rotating motor are obtained. The rotating motor has two forms of motion: rotation and vibration. The rotating motor rotates about the rotating shaft to output torque. A vibration signal of the rotating motor along a vibration direction indicates that there is a sign of fault in the rotating motor. Through analysis on the vibration signal of the rotating motor along the vibration direction, whether a fault occurs in the rotating motor and a type of the fault can be determined.

The vibration direction may be either an axial direction or a radial direction. A plurality of vibration sensors may be arranged in the axial direction and/or the radial direction of the rotating motor, to obtain a vibration signal of the rotating motor along the vibration direction. In some embodiments, the vibration signal may be a time-domain acceleration signal, and the time-domain acceleration signal may be collected by an acceleration sensor, such as a micro-electro-mechanical systems (MEMS) accelerometer.

The time-domain acceleration signal of the rotating motor along the vibration direction is obtained through collection by the acceleration sensor. FIG. 3 shows a time-domain acceleration signal 301 collected by an accelerometer, where the abscissa represents time in the unit of millisecond (ms), the ordinate represents an acceleration value in the unit of m/s², and the time-domain acceleration signal 301 shows acceleration values at different time points. It is worth noting that different accelerometers may have different sampling rates, that is, sampling is performed at intervals of different time points, and different accelerometers may also have different resolutions, that is, collected acceleration values have different decimal places.

The rotation period of the rotating motor can be calculated based on the rotational speed of the rotating motor. Specifically, an encoder collects the rotational speed of the rotating motor, and the rotation period of the rotating motor, that is, the time taken for the rotating motor to rotate by one turn, can be calculated based on the rotational speed. For example, the rotational speed of the rotating motor collected by the encoder is 1800 r/min, that is, 30 revolutions per second, the time for each turn is 1/30second, and the rotation period is 1/30second.

In step 220, the time-domain acceleration signal is converted into a time-domain velocity signal, a plurality of velocity signal segments are cut off along the time-domain velocity signal by taking the rotation period as a step size, and the plurality of velocity signal segments are arranged in sequence to obtain a velocity signal matrix. Converting the time-domain acceleration signal into the time-domain velocity signal may be performing time-domain integration on the time-domain acceleration signal, or performing frequency-domain integration after converting the time-domain acceleration signal into the frequency domain.

When time-domain integration is performed, time-domain integration is directly performed on the time-domain acceleration signal to obtain the time-domain velocity signal. When frequency-domain integration is performed, the time-domain acceleration signal is converted into a frequency-domain acceleration signal through fast Fourier transform (FFT); frequency-domain integration is performed on the frequency-domain acceleration signal to obtain a frequency-domain velocity signal; and the frequency-domain velocity signal is converted into the time-domain velocity signal through inverse fast Fourier transform (IFFT). For this purpose, frequency-domain integration is used to remove high-frequency noise in a vibration signal.

FIG. 3 shows a time-domain velocity signal 302 obtained after conversion of the time-domain acceleration signal 301, where the abscissa represents time in the unit of second (s), the ordinate represents a velocity value in the unit of m/s, and the time-domain velocity signal 302 shows velocity values at different time points. After the time-domain velocity signal is obtained, the plurality of velocity signal segments are cut off along the time-domain velocity signal by taking the rotation period as the step size. The plurality of velocity signal segments may be cut off along the time-domain velocity signal from the initial moment by taking the rotation period as the step size. If there is relatively large noise in the initial parts of the time-domain velocity signal, these signal segments with relatively large noise can be skipped to ensure data reliability and to improve the fault diagnosis accuracy.

In an optional case, the plurality of velocity signal segments are cut off along the time-domain velocity signal in a non-overlapping manner by taking the rotation period as the step size. After the starting point of the initial signal segment is determined, the initial signal segment with a length being the rotation period is obtained along the time-domain velocity signal, a second signal segment with a length being the rotation period is obtained along the time-domain velocity signal by taking data next to a data point at the end of the initial signal segment as the starting point, and so on, the plurality of velocity signal segments may be cut off, and the velocity signal segments cut off have the same number of pieces of velocity data. Adjacent velocity signal segments from the plurality of velocity signal segments do not overlap, thereby improving data stability and fault diagnosis accuracy.

After the plurality of velocity signal segments are obtained, since the velocity signal segments have the same number of pieces of velocity data, the velocity signal segments are arranged in sequence, so that the velocity signal matrix can be obtained. The velocity signal segments may be arranged row by row in sequence from top to bottom or from bottom to top to obtain the velocity signal matrix. Alternatively, the velocity signal segments may be arranged column by column in sequence from left to right or from right to left to obtain the velocity signal matrix.

As shown in FIG. 3, starting from the initial moment, at least four velocity signal segments 302a, 302b, 302c, and 302d are cut off along the time-domain velocity signal 302 in a non-overlapping manner at the rotation period (for example, 1/30second in the example described above), adjacent velocity signal segments do not overlap, the velocity signal segments 302a, 302b, 302c, and 302d have the same number of pieces of velocity data, and the velocity signal segments 302a, 302b, 302c, and 302d are arranged row by row in sequence from bottom to top to obtain the velocity signal matrix 303. As can be seen from the local magnified part 303a of the velocity signal matrix 303, the velocity signal segment 302c includes velocity data 3.5, 12.5, 12.1, and 9.0, and the velocity signal segment 302d includes velocity data 2.4, 11.3, 11.1, and 8.7.

In step 230, the velocity signal matrix is converted into an image. In this step, the velocity signal matrix is converted into the image, to transform a fault diagnosis problem into an image recognition problem, which can be applicable to an image-oriented neural network model and improves fault diagnosis efficiency and accuracy.

In some embodiments, the converting the velocity signal matrix into an image includes: multiplying the velocity signal matrix by a normalization coefficient to obtain a normalized velocity signal matrix; and mapping the normalized velocity signal matrix to the image. The velocity signal matrix is normalized, such that vibration data with different sampling rates and resolutions are all applicable, thereby reducing complexity of the neural network model and improving the fault diagnosis efficiency.

In some embodiments, the velocity signal matrix maybe converted into a color image. The color image may be a red-green-blue (RGB) color image, a cyan-magenta-yellow-key (CMYK) color image, or the like. The velocity signal matrix is converted into the color image, which can increase an image recognition degree and facilitate labeling by technical personnel during training of the neural network model, thereby improving the accuracy of the neural network model for fault diagnosis.

The RGB color image is used as an example, the velocity signal matrix is multiplied by the normalization coefficient, such that a maximum value of values of velocity data in the velocity signal matrix is approximately 255, and then pseudo color rules such as those in MATLAB are used to map the velocity signal matrix to the RGB color image. FIG. 3 shows a velocity signal matrix 304 normalized with a normalization coefficient of 10. As can be seen from the local magnified part 304a of the normalized velocity signal matrix 304, the velocity data of the velocity signal segment 302c is normalized to 35, 125, 121, and 90, and the velocity data of the velocity signal segment 302d is normalized to 24, 113, 111, and 87. The RGB image 305 can be obtained by converting the normalized velocity signal matrix 304 using the pseudo color rules.

In some embodiments, after the velocity signal matrix is converted into the image, a size of the image is adjusted to a predetermined size for the neural network model, for example, 320 mm×320 mm. The size of the image is adjusted to the predetermined size for the neural network model, which can reduce the complexity of the neural network model and improve the fault diagnosis efficiency. In FIG. 3, the RGB image 305 is resized to an image 306, and a size of the image 306 is 320 mm×320 mm.

In step 240, the image is input into a trained neural network model to obtain a fault diagnosis result. The neural network model may be an AlexNet or GoogleNet neural network model. In some embodiments, the neural network model may be trained by using an image data set. Training the neural network model may include: (1) labeling a type of a fault to be recognized, and converting the fault into a file in a format required for training; (2) dividing the converted image file into a training set and a test set, using the training set to train the neural network model, and using the test set to test the trained neural network model.

After testing, the trained neural network model can be obtained, and the image output in step 230 can be analyzed and processed using the trained neural network model, to obtain the fault diagnosis result. For example, faults such as unbalance, looseness, and eccentricity can be diagnosed based on the input image, and if the labeled fault type is not recognized, it is determined that no fault has occurred in the rotating motor. For example, the image 306 shown in FIG. 3 is a typical unbalanced image, the image 306 is input into the neural network model, and the fault diagnosis result obtained is that an unbalanced fault occurs.

In some embodiments, the velocity signal matrix is converted into the image, and the image is input into the trained neural network model, so that the fault diagnosis result is obtained, thereby transforming a fault diagnosis problem into an image recognition problem, which is applicable to an image-oriented neural network model and improves fault diagnosis efficiency and accuracy.

A flowchart is used herein to illustrate the operations performed in a method incorporating teachings of the present disclosure. It should be understood that the operations described above are not necessarily performed exactly in order. Instead, the various steps may be processed in reverse order or simultaneously. In addition, other operations are added to these processes, or a certain step or several operations are removed from these processes.

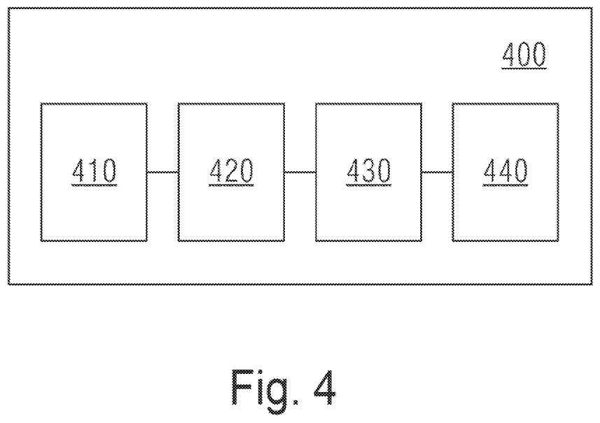

FIG. 4 is a block diagram of a fault diagnosis apparatus 400 incorporating teachings of the present dislcosure. As shown in FIG. 4, the fault diagnosis apparatus 400 in the embodiment includes: an obtaining unit 410 obtaining a time-domain acceleration signal of the rotating motor along a vibration direction and a rotation period of the rotating motor; an alignment and arrangement unit 420 converting the time-domain acceleration signal into a time-domain velocity signal, cutting off a plurality of velocity signal segments along the time-domain velocity signal by taking the rotation period as a step size, and arranging the plurality of velocity signal segments in sequence to obtain a velocity signal matrix; a conversion unit 430 converting the velocity signal matrix into an image; and a determining unit 440 inputting the image into a trained neural network model to obtain a fault diagnosis result.

In some embodiments, converting, by the obtaining unit 410, the time-domain acceleration signal into a time-domain velocity signal includes: converting the time-domain acceleration signal into a frequency-domain acceleration signal through fast Fourier transform; performing frequency-domain integration on the frequency-domain acceleration signal to obtain a frequency-domain velocity signal; and converting the frequency-domain velocity signal into the time-domain velocity signal through inverse fast Fourier transform.

In some embodiments, cutting off, by the alignment and arrangement unit 420, a plurality of velocity signal segments along the time-domain velocity signal by taking the rotation period as a step size includes cutting off the plurality of velocity signal segments along the time-domain velocity signal in a non-overlapping manner by taking the rotation period as the step size.

In some embodiments, converting, by the conversion unit 430, the velocity signal matrix into an image includes: multiplying the velocity signal matrix by a normalization coefficient to obtain a normalized velocity signal matrix; and mapping the normalized velocity signal matrix to the image.

In some embodiments, converting, by the conversion unit 430, the velocity signal matrix into an image includes converting the velocity signal matrix into a color image. In some embodiments, after the converting, by the conversion unit 430, the velocity signal matrix into an image, the following step is further included adjusting a size of the image to a predetermined size for the neural network model. For implementations and specific processes of the fault diagnosis apparatus 400, reference maybe made to the fault diagnosis method 300, which is not repeated herein.

In some embodiments, an electronic device includes a processor, a memory, and instructions stored in the memory, where when the instructions are executed by the processor, one or more of the methods as described above is implemented. In some embodiments, there is a computer-readable storage medium having computer instructions stored thereon, where when the computer instructions are run, one or more of the above methods is performed.

Some aspects of the method and apparatus of the present disclosure maybe completely executed by hardware, or may be completely executed by software (including firmware, resident software, microcode, etc.), or may be executed by a combination of hardware and software. The hardware or software described above may all be referred to as “data block”, “module”, “engine”, “unit”, “component”, or “system”. The processor may be one or more application-specific integrated circuits (ASICs), digital signal processors (DSPs), digital signal processing devices (DSPDs), programmable logic devices (PLDs), field-programmable gate arrays (FPGAs), processors, controllers, microcontrollers, microprocessors, or a combination thereof. In addition, various aspects of the present invention may be embodied as a computer product in one or more computer-readable media, and the product includes computer-readable program code. For example, the computer-readable media may include, but are not limited to, a magnetic storage device (for example, a hard disk, a floppy disk, a tape . . . ), an optical disc (for example, a compact disc (CD), a digital versatile disc (DVD) . . . ), a smart card, and a flash memory device (for example, a card, a stick, a key drive . . . ).

The computer-readable medium may include a propagation data signal including computer program code, for example, on a baseband or as a part of a carrier. The propagation signal may be represented in a plurality of forms, including an electromagnetic form, an optical form, or the like, or a proper combination form. The computer-readable medium may be any computer-readable medium other than a computer-readable storage medium, and the medium may be connected to an instruction executing system, apparatus, or device, to implement the communication, propagation, or transmission of a program for use. The program code on the computer-readable medium may be propagated over any suitable medium, including radio, a cable, a fiber optic cable, a radio frequency (RF) signal, a similar medium, or any combination of the above media.

It should be understood that, although the description is given according to each of the embodiments, but each embodiment does not only comprise an independent technical solution, this narration manner of the description is only for clarity, and for a person skilled in the art, the description shall be regarded as a whole, and the technical solution in each of the embodiments can also be properly combined to form other implementations that can be understood by a person skilled in the art.

What are described above are merely illustrative particular embodiments of the present disclosure and are not intended to limit the scope thereof. Any equivalent variation, modification, and combination made by anyone skilled in the art without departing from the concept and principles of the present disclosure shall belong to the protective scope of the present disclosure.

What is claimed is:

1. A fault diagnosis method for a rotating motor, the method comprising:
obtaining a time-domain acceleration signal of the rotating motor along a vibration direction and a rotation period of the rotating motor;
converting the time-domain acceleration signal into a time-domain velocity signal, cutting off a plurality of velocity signal segments along the time-domain velocity signal by taking the rotation period as a step size, and arranging the plurality of velocity signal segments in sequence to obtain a velocity signal matrix;
converting the velocity signal matrix into an image; and
inputting the image into a trained neural network model to obtain a fault diagnosis result.

2. The fault diagnosis method according to claim 1, wherein converting the time-domain acceleration signal into a time-domain velocity signal comprises:
converting the time-domain acceleration signal into a frequency-domain acceleration signal through fast Fourier transform;
performing frequency-domain integration on the frequency-domain acceleration signal to obtain a frequency-domain velocity signal; and
converting the frequency-domain velocity signal into the time-domain velocity signal through inverse fast Fourier transform.

3. The fault diagnosis method according to claim 1, wherein cutting off a plurality of velocity signal segments along the time-domain velocity signal by taking the rotation period as a step size comprises cutting off the plurality of velocity signal segments along the time-domain velocity signal in a non-overlapping manner by taking the rotation period as the step size.

4. The fault diagnosis method according to claim 1, wherein converting the velocity signal matrix into an image comprises:
multiplying the velocity signal matrix by a normalization coefficient to obtain a normalized velocity signal matrix; and
mapping the normalized velocity signal matrix to the image.

5. The fault diagnosis method according to claim 4, wherein converting the velocity signal matrix into an image comprises converting the velocity signal matrix into a color image.

6. The fault diagnosis method according to claim 1, wherein, after converting the velocity signal matrix into an image, the method further comprises adjusting a size of the image to a predetermined size for the neural network model.

7. A fault diagnosis apparatus for a rotating motor, the apparatus comprising:
an obtaining unit obtaining a time-domain acceleration signal of the rotating motor along a vibration direction and a rotation period of the rotating motor;
an alignment and arrangement unit converting the time-domain acceleration signal into a time-domain velocity signal, cutting off a plurality of velocity signal segments along the time-domain velocity signal by taking the rotation period as a step size, and arranging the plurality of velocity signal segments in sequence to obtain a velocity signal matrix;
a conversion unit converting the velocity signal matrix into an image; and
a determining unit inputting the image into a trained neural network model to obtain a fault diagnosis result.

8. The fault diagnosis apparatus according to claim 7, wherein converting, by the obtaining unit, the time-domain acceleration signal into a time-domain velocity signal comprises:
converting the time-domain acceleration signal into a frequency-domain acceleration signal through fast Fourier transform;
performing frequency-domain integration on the frequency-domain acceleration signal to obtain a frequency-domain velocity signal; and
converting the frequency-domain velocity signal into the time-domain velocity signal through inverse fast Fourier transform.

9. The fault diagnosis apparatus according to claim 7, wherein cutting off, by the alignment and arrangement unit, a plurality of velocity signal segments along the time-domain velocity signal by taking the rotation period as a step size comprises cutting off the plurality of velocity signal segments along the time-domain velocity signal in a non-overlapping manner by taking the rotation period as the step size.

10. The fault diagnosis apparatus according to claim 7, wherein converting the velocity signal matrix into an image comprises:
multiplying the velocity signal matrix by a normalization coefficient to obtain a normalized velocity signal matrix; and
mapping the normalized velocity signal matrix to the image.

11. The fault diagnosis apparatus according to claim 10, wherein converting the velocity signal matrix into an image comprises converting the velocity signal matrix into a color image.

12. The fault diagnosis apparatus according to claim 7, wherein, after converting the velocity signal matrix into an image, the conversion unit adjust a size of the image to a predetermined size for the neural network model.

13. An electronic device, comprising:
a processor; and
a memory storing instructions;
wherein when the instructions are executed by the processor, the instructions cause the processor to:
obtain a time-domain acceleration signal of the rotating motor along a vibration direction and a rotation period of the rotating motor;
convert the time-domain acceleration signal into a time-domain velocity signal, cutting off a plurality of velocity signal segments along the time-domain velocity signal by taking the rotation period as a step size, and arranging the plurality of velocity signal segments in sequence to obtain a velocity signal matrix;
convert the velocity signal matrix into an image; and
input the image into a trained neural network model to obtain a fault diagnosis result.

14. (canceled)
